(19) United States
(12) Patent Application Publication
(10) Pub. No.: US 2012/0219834 A1
(43) Pub. Date: Aug. 30, 2012

(54) SECONDARY BATTERY

(76) Inventor: Jeongman PARK, Yongin-si (KR)

(21) Appl. No.: 13/401,001

(22) Filed: Feb. 21, 2012

(30) Foreign Application Priority Data
Feb. 18, 2011 (KR) 10-2011-0014658

(51) Int. Cl. H01M 10/52; H01M 2/04; H01M 2/12

(52) U.S. Cl. 429/89

(57) ABSTRACT

A secondary battery includes a case having an interior cavity and an upper opening, an electrode assembly disposed in the interior cavity of the case, a cap assembly, and a vent cover disposed on an outer surface of the cap plate and at least partially covering the safety vent. The cap assembly includes a cap plate and a safety vent formed within the cap plate, the safety vent being thinner than a remainder of the cap plate, and the cap plate coupled with the upper opening of the case. A portion of the vent cover, corresponding in position to the position of the safety vent, is thinner than a remaining portion of the vent cover.

### BACKGROUND

1. Field

Embodiments relate to a secondary battery.

2. Description of the Related Art

In general, secondary batteries can be charged and discharged, and used repetitively. Secondary batteries are used in such portable electronic devices as mobile phones, laptops, computers, cameras, and camcorders, or used as power sources for driving motors of high-power hybrid electric vehicles, electric vehicles, electric scooters, etc.

A secondary battery includes an electrode assembly, a case accommodating the electrode assembly, and a cap assembly coupled with an upper portion of the case.

### SUMMARY

Embodiments are therefore directed to a secondary battery, which substantially overcome one or more problems due to the limitations and disadvantages of the related art.

It is therefore a feature of an embodiment to provide a secondary battery that includes a vent cover to protect a safety vent before the safety vent is in operation.

It is therefore another feature of an embodiment to provide a secondary battery that allows gas to be discharged when the safety vent is in operation.

Embodiments may be realized by providing a secondary battery including a case having an interior cavity and an upper opening, an electrode assembly disposed in the interior cavity of the case, a cap assembly, and a vent cover disposed on an outer surface of the cap plate and at least partially covering the safety vent. The cap assembly may include a cap plate and a safety vent formed within the cap plate, the safety vent being thinner than a remainder of the cap plate, and the cap plate coupled with the upper opening of the case. A portion of the vent cover corresponding in position to the position of the safety vent may be thinner than a remaining portion of the vent cover.

According to some embodiments, the vent cover may include at least one of a groove or notch on a surface of the vent cover facing the safety vent. According to some embodiments, the groove may have a shape that is identical to a shape of the safety vent. According to some embodiments, the groove may include a first groove and a second groove, and the second groove may be intersecting with the first groove. According to some embodiments, the first groove and the second groove may intersect orthogonally. According to some embodiments, the first groove and the second groove may be linear.

According to some embodiments, the first groove and the second groove are a plurality of dotted lines. According to some embodiments, the groove may include a first groove disposed at a center of the vent cover and a second groove and a third groove which extend from both ends of the first groove toward corners of the vent cover. According to some embodiments, the first groove, the second groove, and the third groove may be linear.

According to some embodiments, the groove may include a branched groove having a main groove, and first and second V-shaped grooves extending from opposing ends of the main groove. According to some embodiments, the main groove may be in a center of the vent cover and the V-shaped grooves may extend towards corners of the vent cover. According to some embodiments, the groove may be linear.

According to some embodiments, the notch may include a first notch and a second notch, the first notch and the second notch may be intersecting each other. According to some embodiments, the first notch and the second notch may intersect orthogonally. According to some embodiments, the first notch and the second notch may be a plurality of dotted lines. According to some embodiments, the plurality of notches may include a first plurality of notches arranged in a first line and a second plurality of notches arranged in a second line. The first and second lines may be intersecting. According to some embodiments, the first and second lines may intersect orthogonally.

According to some embodiments, the notch may include a branched notch having a main notch, and first and second V-shaped notches extending from opposing ends of the main notches. According to some embodiments, the notch may be linear. According to some embodiments, the vent cover may be formed of an insulating material.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a perspective view of a secondary battery according to an embodiment in a disassembled state;

FIG. 2 illustrates a perspective view of the secondary battery of FIG. 1 in an assembled state;

FIG. 3 illustrates a sectional view of a vent cover of the secondary battery of FIG. 2;

FIG. 4 illustrates an enlarged perspective view of the vent cover of the secondary battery of FIG. 2;

FIG. 5A illustrates an enlarged perspective view of a vent cover of a secondary battery according to another embodiment;

FIG. 5B illustrates an enlarged perspective view of a vent cover of a secondary battery according to another embodiment;

FIG. 6A illustrates an enlarged perspective view of a vent cover of a secondary battery according to another embodiment;

FIG. 6B illustrates an enlarged perspective view of a vent cover of a secondary battery according to another embodiment;

FIG. 7A illustrates an enlarged perspective view of a vent cover of a secondary battery according to another embodiment; and

FIG. 7B illustrates an enlarged perspective view of a vent cover of a secondary battery according to another embodiment.

### DETAILED DESCRIPTION

Korean Patent Application No. 10-2011-0014658 filed on Feb. 18, 2011, in the Korean Intellectual Property Office, and entitled: “Secondary Battery” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments will be described in detail with reference to the accompanying drawings.

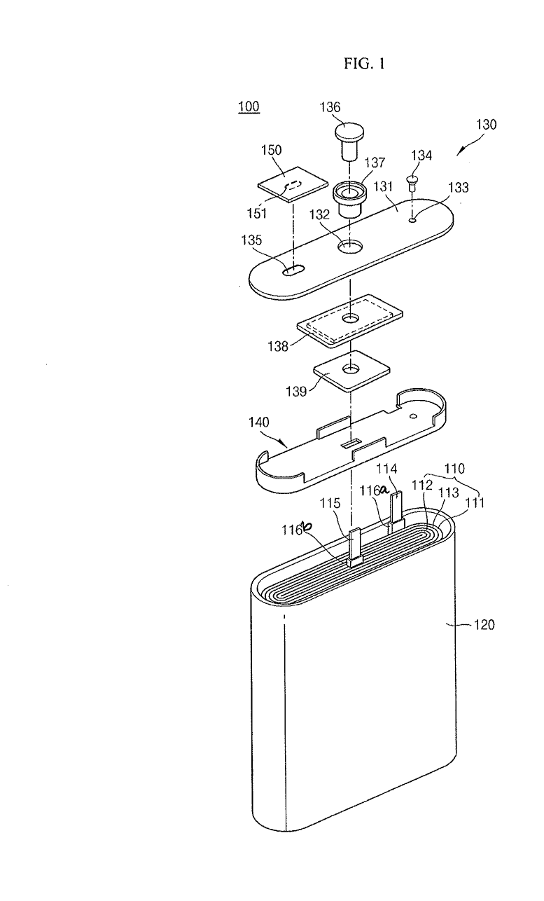

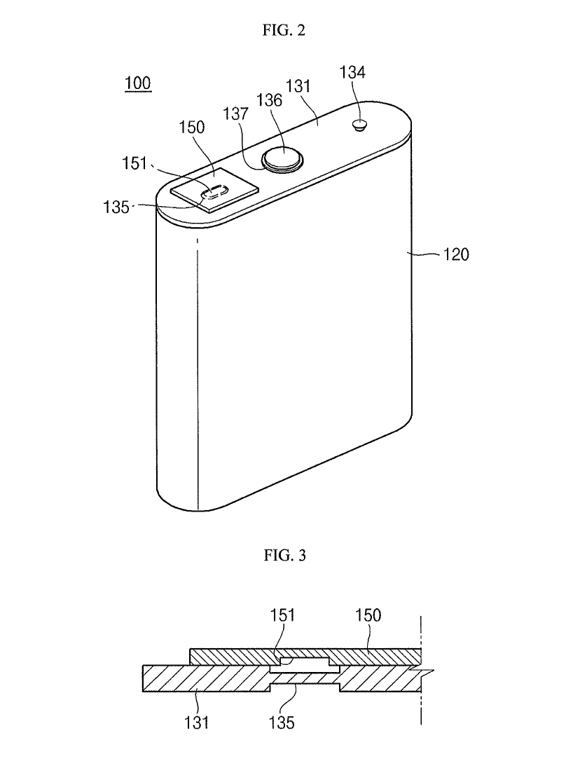

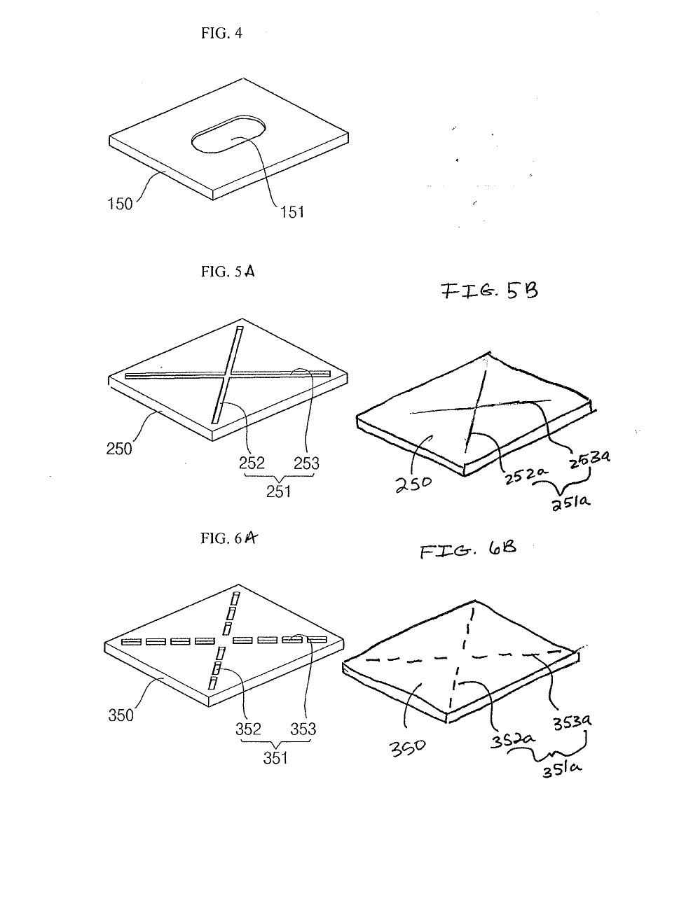

FIG. 1 is a perspective view illustrating a secondary battery according to an embodiment in a disassembled state, and FIG. 2 is a perspective view illustrating the secondary battery of FIG. 1 in an assembled state. FIG. 3 is a sectional view illustrating a vent cover of the secondary battery of FIG. 2, and FIG. 4 is an enlarged perspective view illustrating the vent cover of the secondary battery of FIG. 2. Here, FIG. 4 illustrates a state in which a lower surface of the vent cover faces upwards.

Referring to FIGS. 1 and 2, a secondary battery 100 of the current embodiment may include an electrode assembly 110, a case 120, a cap assembly 130, an insulating case 140, and a vent cover 150.

The electrode assembly 110 may be a laminate formed by winding or overlapping a first electrode plate 111, a separator 113, and a second electrode plate 112. The first electrode plate 111, the separator 113, and the second electrode plate 112 may each be formed as a thin plate or film. In addition, the electrode assembly 110 may include a first electrode tab 114 and a second electrode tab 115.

The first electrode plate 111 may include a first electrode collector. The first electrode collector may be formed of aluminum foil. A first electrode active material may be disposed in the first electrode collector. A material such as lithium cobalt oxide may be used as the first electrode active material.

The second electrode plate 112 may include a second electrode collector formed of copper foil, and a second electrode active material disposed in the second electrode collector. A material such as carbon may be used as the second electrode active material.

The first electrode plate 111 may be positive electrode, and the second electrode plate 112 may be negative electrode. In addition, the first electrode plate 111 and the second electrode plate 112 may have different polarities.

The separator 113 may be formed of polyethylene, polypropylene, or a copolymer of polyethylene and polypropylene. The separator 113 may have a larger width than the first electrode plate 111 and the second electrode plate 112 to prevent a short circuit between the electrode plates. According to some embodiments, the separator 113 may have a larger width than the combined widths of the first electrode plate 111 and the second electrode plate 112. According to some embodiments, the separator 113 may have a larger width than the width of the first electrode plate 111. According to some embodiments, the separator 113 may have a larger width than the width of the second electrode plate 112.

FIG. 1 shows the first electrode tab 114 and the second electrode tab 115 extending out of the first electrode plate 111 and the second electrode plate 112, respectively. The first electrode tab 114 and the second electrode tab 115 may be disposed in the first electrode plate 111 and the second electrode plate 112, respectively. The first electrode tab 114 may be pulled to extend out of the first electrode plate 111. The second electrode tab 115 may be pulled to extend out of the second electrode plate 112. Insulating tape 116a may be provided at boundary portions or edge portions of the first electrode plate 111 from which the first electrode tab 114 extends. Insulating tape 116b may be provided at boundary or portions or edge portions of the second electrode plate 112 from which the second electrode tab 115 extends. Insulating tapes 116a and 116b may prevent short circuit between the electrode plates.

The case 120 may be a metal can. The case 120 may be formed by a processing method such as deep drawing. The case 120 may be formed of such a lightweight conductive metal as aluminum or aluminum alloy. Thus, the case 120 may act as an electrode. According to some embodiments, the case 120 may act as a positive electrode. The case 120 may contain the electrode assembly 110 and an electrolyte. An upper opening of the case 120, which is configured to receive the electrode assembly 110, may be sealed with the cap assembly 130.

The cap assembly 130 may include a cap plate 131, a stopper 134, a safety vent 135, and an electrode terminal 136.

The cap plate 131 may be a metal plate having a size and a shape corresponding to a size and a shape of the upper opening of the case 120. The cap plate 131 may be coupled with the case 120 by, for example, welding, and may act as a positive electrode like the case 120. A terminal hole 132 may be disposed at a center of the cap plate 131. In addition, an electrolyte inlet 133 may be defined in the cap plate 131 proximate a first end of the cap plate 131.

The electrolyte may be injected into the case 120 through the electrolyte inlet 133. The stopper 134 may be configured to seal the electrolyte inlet 133 after the electrolyte is injected into the case 120. In general, the stopper 134 may be ball-shaped base metal. The metal may be aluminum or a metal containing aluminum. The stopper 134 may be pressed into the electrolyte inlet 133 mechanically, and engage the electrolyte inlet 133.

The safety vent 135 may be disposed in the cap plate 131, proximate a second end of the cap plate, which opposes the first end of the cap plate 131. The safety vent 135 may further protect the secondary battery 100 by discharging gas when an internal pressure of the secondary battery 100 is larger than a reference pressure, for example, due to overcharge.

The electrode terminal 136 may pass through the cap plate 131 via the terminal hole 132. The electrode terminal 136 may be inserted into a tube-shaped gasket 137 prior to insertion in the terminal hole 132. The tube-shaped gasket may cover or surround at least a portion of an outer surface of the electrode terminal 136 to insulate the electrode terminal 136 and the cap plate 131. An insulating plate 138 may be disposed on a lower surface of the cap plate 131, and a terminal plate 139 may be disposed on a lower surface of the insulating plate 138. A bottom surface of the electrode terminal 136 may be electrically connected to the terminal plate 139. The electrode terminal 136 may be electrically connected to the second electrode plate 112 of the electrode assembly 110 through the second electrode tab 115 of the electrode assembly 110. The first electrode plate 111 of the electrode assembly 110 may be electrically connected to the cap plate 131 through the first electrode tab 114.

The insulating case 140 may be disposed between the electrode assembly 110 and the cap assembly 130. The insulating case 140 may prevent an electric short circuit between the electrode assembly 110 and the cap assembly 130, and may support and/or fix the first electrode tab 114 and the second electrode tab 115. Therefore, the insulating case 140 may be formed of an insulating material.

The vent cover 150 may be disposed on an outer surface of the cap plate 131 to cover the safety vent 135. When, for example, an upper cover using a hot-melting resin is disposed on the cap plate 131, the vent cover 150 may protect the safety vent 135 from a melting pressure of the hot-melting resin, and may prevent the safety vent 135 from being damaged by the melting pressure. In addition, the vent cover 150 may prevent the safety vent 135 from being damaged by an external force before the safety vent 135 is put into operation.

Hereinafter, the safety vent 135 and the vent cover 150 are described in more detail. The safety vent 135 may include an indented portion or thinner portion of the cap plate 131, as shown more clearly in FIG. 3. The safety vent 135 may be formed by providing a groove in the top surface, bottom surface, or both top and bottom surfaces of the cap plate 131. The safety vent 135 may be fractured first when the internal pressure of the secondary battery 100 is larger than the reference pressure, to facilitate discharge of gas.

Referring to FIGS. 3 and 4, at least a part of the vent cover 150 corresponding to or aligned with the safety vent 135 may be thinner than the rest of the vent cover 150. According to an embodiment, the vent cover 150 may include a groove 151 disposed on a surface facing the safety vent 135. The vent cover 150 may protect the safety vent 135 before the safety vent 135 is in operation. When the safety vent 135 is in operation and is fractured, the groove 151 may be fractured to facilitate discharge of gas out of the secondary battery 100 through the vent cover 150.

Although the groove 151 is illustrated as having a smaller size than the safety vent 135, the groove 151 may be bigger than the safety vent 135. The groove 151 may have a shape identical to a shape of the safety vent 135 and may be disposed at a position corresponding to the safety vent 135, so that gas may be discharged more efficiently. The vent cover 150 may be formed of an insulating material such as insulating tape.

As described above, the secondary battery 100 according to an embodiment including the vent cover 150, may have the groove 151 defined therein, so that at least the part of the vent cover 150 corresponding to the safety vent 135 is thinner than the rest of the vent cover 150. The vent cover 150 may protect the safety vent 135 before the safety vent 135 is in operation. When the safety vent 135 is in operation and is fractured, the groove 151 may be fractured to facilitate discharge of gas out of the secondary battery 100 through the vent cover 150. Therefore, the secondary battery 100 according to the embodiment may provide increased stability.

A secondary battery will now be described according to another embodiment. FIGS. 5A and 5B are enlarged perspective views illustrating another embodiment of a vent cover of the secondary battery, which is designated 250. FIGS. 5A and 5B illustrate a lower surface of the vent cover 250 facing upwards. The secondary battery may include the vent cover 250 instead of the vent cover 150, and all other components, as well as the function of the secondary battery, may be as described above for the secondary battery of FIG. 1. Therefore, the description that immediately follows relates primarily to the vent cover 250.

Referring to FIG. 5A, the vent cover 250 may be similar to the vent cover 150 except that the vent cover 150 may have an X-shaped groove 251 instead of the groove 151. The X-shaped groove 251 of the vent cover 250 may include a first rectangular groove 252 and a second rectangular groove 253, which intersect each other to form an X shape. Each of the first rectangular groove 252 and the second rectangular groove 253 can have a narrow width. Pressure created by gas that is discharged from the safety vent 135 when the safety vent 135 is in operation and is fractured, may be concentrated on the groove 251, resulting in fracturing of the vent cover 250.

Although FIG. 5A illustrates the vent cover 250 with grooves 251 that have a predetermined width, the vent cover 250 may, instead, be simply configured to include an X-shaped notch 251a, as shown in FIG. 5B. In other words, the notch 251a may simply be narrow or be formed without controlling for a predetermined width or depth. In this case, the X-shaped notch 251a may include a first notch 252a and a second notch 253a, which intersect each other to form an X-shape.

As described above, the secondary battery according to an embodiment having the vent cover 250, may have an X-shaped groove 251 or an X-shaped notch defined in the vent cover 250, to facilitate fracturing of the vent cover 250 to discharge gas when the safety vent 135 is in operation and is fractured. Therefore, the secondary battery according to the embodiment may provide increased stability.

A secondary battery will now be described according to another embodiment. FIGS. 6A and 6B are enlarged perspective views of another embodiment of a vent cover of the secondary battery, which is designated 350 in the figures. Here, FIGS. 6A and 6B illustrates a lower surface of the vent cover, facing upwards. The secondary battery may include the vent cover 350 instead of the vent cover 150, and all other components, as well as the function of the secondary battery, may be as described above for the secondary battery of FIG. 1. Therefore, the description that immediately follows relates primarily to the vent cover 350.

Referring to FIG. 6A, the vent cover 350 may be similar to the vent cover 150 except that the vent cover 350 may include an X-shaped arrangement of a plurality of grooves 351 instead of the groove 151. The X-shaped arrangement of a plurality of grooves 351 may include a first plurality of grooves 352 and a second plurality of grooves 353. The first plurality of grooves 352 may include a first set of individual grooves aligned in a linear fashion with respect to one another. The second plurality of grooves 353 may include a second set of individual grooves aligned in a linear fashion with respect to one another. The first plurality of grooves 352 and the second plurality of grooves 353 may intersect each other to form an X shape. Each individual groove of the first plurality of grooves 352 and the second plurality of grooves 353 can have a narrow width. Pressure created by gas that is discharged from the safety vent 135 when the safety vent 135 is in operation and is fractured, may be concentrated on the groove 351, resulting in fracturing of the vent cover 350. Even when the pressure created by the gas discharged from the safety vent 135 is weak, the fracturing of the vent cover 350 may be facilitated. In other words, the reference pressure which is set to put the safety vent 135 into operation is adjustable.

Although FIG. 6A illustrates the vent cover 350 including the X-shaped arrangement of a plurality of grooves 351 which has a predetermined width, the vent cover 350 may, instead, be simply configured to include an X-shaped arrangement of a plurality of notches 351a, as shown in FIG. 6B. In this case, the X-shaped arrangement of a plurality of notches 351a may include a first plurality of notches 352a and a second plurality of notches 353a, which intersect each other to form an X-shape.

As described above, the secondary battery according to an embodiment having the vent cover 350, may have an X-shaped arrangement of a plurality of grooves, to facilitate fracturing of the vent cover 350 to discharge gas when the safety vent 135 is in operation and is fractured. Even when the pressure created by the gas discharged from the safety vent 135 is weak, the fracturing of the vent cover 350 may be facilitated. Therefore, the secondary battery according to the embodiment may provide increased stability.

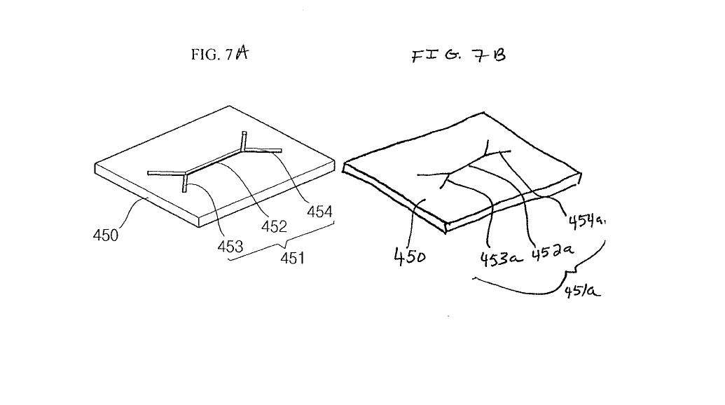

A secondary battery will now be described according to another embodiment. FIGS. 7A and 7B are enlarged perspective views illustrating another embodiment of a vent cover of the secondary battery, which is designated 450 in the figures. Here, FIGS. 7A and 7B illustrate a lower surface of the vent cover 450, facing upwards. The secondary battery may include the vent cover 450 instead of the vent cover 150, and all other components, as well as the function of the secondary battery, may be as described above for the secondary battery of FIG. 1. Therefore, the description that immediately follows relates primarily to the vent cover 450.

Referring to FIG. 7A, the vent cover 450 may be similar to the vent cover 150 except that the vent cover 450 may include a branched groove 451 instead of the groove 151. The branched groove 451 may include a rectangular main groove 452 having first and second opposing ends, a first V-shaped groove 453 extending from the first end toward a first edge of the vent cover 450, and a second V-shaped groove 454 extending from the second end toward a second, opposing edge of the vent cover 450. Specifically, the rectangular main groove 452 may extend horizontally across a center of the vent cover 450. The branched groove 451 may have a narrow width. Pressure created by the gas discharged from the safety vent 135 when the safety vent 135 is in operation and is fractured, may be concentrated on the rectangular main groove 452, resulting in fracturing of the vent cover 350. In addition, the first V-shaped groove 453 and the second V-shaped groove 454 may be fractured when the rectangular main groove 454 is fractured, and an area through which the gas of the secondary battery may be discharged may be widened.

Although FIG. 7A illustrates the vent cover 450 including the branched groove 451 which has a predetermined width, the vent cover 450 may, instead, be simply configured to include a branched notch 451a, as shown in FIG. 7B. In this case, the branched notch 451a includes a first V-shaped notch 453a and a second V-shaped notch 454a that extend from opposing ends of a rectangular main notch 451a.

As described above, the secondary battery according to an embodiment having the vent cover 450 having the branched groove 451 or the branched notch 451a, may easily discharge gas by facilitating fracturing of the vent cover 450 and by widening the area through which the gas of the secondary battery is discharged when the safety vent 135 is in operation and is fractured. Therefore, the secondary battery according to the embodiment may provide increased stability.

The secondary battery according to various embodiments, which includes the vent cover having a groove, so that at least the part of the vent cover corresponding to the safety vent is thinner than the rest of the vent cover, may protect the safety vent before the safety vent is put into operation. The secondary battery may easily discharge gas by facilitating the fracturing of the vent cover when the safety vent is in operation and is fractured. Therefore, the secondary battery according to embodiments may provide increased stability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a case having an interior cavity and an upper opening;
an electrode assembly disposed in the interior cavity of the case;
a cap assembly including a cap plate and a safety vent formed within the cap plate, the safety vent being thinner than a remainder of the cap plate, and the cap plate coupled with the upper opening of the case;
and
a vent cover disposed on an outer surface of the cap plate and at least partially covering the safety vent,
wherein a portion of the vent cover corresponding in position to the position of the safety vent is thinner than a remaining portion of the vent cover.

2. The secondary battery as claimed in claim 1, wherein the vent cover includes at least one of a groove or notch on a surface of the vent cover facing the safety vent.

3. The secondary battery as claimed in claim 2, wherein the groove has a shape identical to a shape of the safety vent.

4. The secondary battery as claimed in claim 2, wherein the groove includes a first groove and a second groove, the second groove intersecting with the first groove.

5. The secondary battery as claimed in claim 4, wherein the first and second grooves intersect orthogonally.

6. The secondary battery as claimed in claim 4, wherein the first groove and the second groove are linear.

7. The secondary battery as claimed in claim 4, wherein the first groove and the second groove are a plurality of dotted lines.

8. The secondary battery as claimed in claim 2, wherein the groove includes:
a first groove disposed at a center of the vent cover; and
a second groove and a third groove, the second groove and the third groove extending from both ends of the first groove toward corners of the vent cover.

9. The secondary battery as claimed in claim 8, wherein the first groove, the second groove, and the third groove are linear.

10. The secondary battery as claimed in claim 2, wherein the groove includes:
a branched groove including a main groove, and first and second V-shaped grooves extending from opposing ends of the main groove.

11. The secondary battery as claimed in claim 10, wherein the main groove is in a center of the vent cover and the V-shaped grooves extend towards corners of the vent cover.

12. The secondary battery as claimed in claim 10, wherein the groove is linear.

13. The secondary battery as claimed in claim 2, wherein the notch includes a first notch and a second notch, the first notch and the second notch intersecting each other.

14. The secondary battery as claimed in claim 13, wherein the first notch and the second notch intersect orthogonally.

15. The secondary battery as claimed in claim 13, wherein the first notch and the second notch are a plurality of dotted lines.

16. The secondary battery as claimed in claim 13, wherein the first notch includes a first plurality of notches arranged in a first line and the second notch includes a second plurality of notches arranged in a second line, the first and second lines intersecting.

17. The secondary battery as claimed in claim 16, wherein the first and second lines intersect orthogonally.

18. The secondary battery as claimed in claim 2, wherein the notch includes:
a branched notch including a main notch, and first and second V-shaped notches extending from opposing ends of the main notch.

19. The secondary battery as claimed in claim 2, wherein the notch is linear.

20. The secondary battery as claimed in claim 1, wherein the vent cover is formed of an insulating material.
